(19) United States
(12) Patent Application Publication
(10) Pub. No.: US 2015/0100617 A1
(43) Pub. Date: Apr. 9, 2015

(54) REQUEST HANDLING IN NETWORK ATTACHED STORAGE SYSTEMS

(71) Applicant: International Business Machines Corporation, Armonk, NY (US)

(72) Inventors: Michael Diederich, Mainz (DE); Ingo F. Meents, Mainz (DE); Rainer Wolafka, Hofheim-Langenhain (DE); Horst Zisgen, Nierstein (DE)

(21) Appl. No.: 14/499,773

(22) Filed: Sep. 29, 2014

(30) Foreign Application Priority Data
Oct. 4, 2013 (GB) 1317617.7

(51) Int. Cl. H04L 29/08

(52) U.S. Cl. CPC H04L 67/325; H04L 67/1097
USPC 709/201

(57) ABSTRACT

In one embodiment, an improved network attached storage system is disclosed comprising a storage system connected to at least one external device via an external network. The storage system comprises at least one storage media and at least one controller presenting storage capacity of the storage system to the at least one external device. The at least one external device sends a request to the storage system, and the at least one controller receives and serves the request and sends a response to the requesting external device after serving the request. The at least one controller comprises a delay functionality, which introduces a variable length delay to an execution process of the request based on a current input/output load of the storage system, a maximum allowed request response time, a request completion time, and a measured current request execution time.

### CROSS-REFERENCE TO RELATED PATENT APPLICATION(S)

Pursuant to 35 U.S.C. §119, the present application claims priority to UK Patent Application No. 1317617.7, filed Oct. 4, 2013, the entire contents of which are incorporated herein by reference.

### FIELD OF THE INVENTION

The present invention relates in general to the field of storage systems management, and in particular to a network attached storage system and a corresponding method for request handling in a network attached storage system. Still more particularly, the present invention relates to a data processing program and a computer program product for request handling in a network attached storage system.

### BACKGROUND

The technical area of this invention is about network attached storage (NAS) client management strategies and their application in network attached storage (NAS) systems, especially a storage system supporting the CIFS (Common Internet File System) protocol; although the invention is not limited only for this application.

Network attached storage (NAS) systems provide their internal storage capacity via a network to network attached storage (NAS) clients such as servers, personal computers, mobile devices and others. Any such client may or may not access the network attached storage (NAS) at any time, so there is no dependable prediction of how much Input/output (I/O) load a network attached storage (NAS) system will experience. As I/O load increases, the network attached storage (NAS) system may not be able to serve all clients in time, causing disconnects of clients that are not served in time (timeout of the I/O request). Such disconnects are disruptive from a client perspective and as such expose a serious problem in today's network attached storage (NAS) environments.

FIG. 1 shows a prior art method for request handling in a network attached storage system 1 according to prior art; and FIG. 2 shows the distribution of completion time for a fixed load, in accordance with the prior art method for request handling in the prior art network attached storage system 1 of FIG. 1.

Referring to FIG. 1 the network attached storage system 1 comprises a storage system 100 comprising one or more controllers 110 which present the storage capacity of the storage system 100 via an external network 190 to one or more clients 180. Each storage controller 110 can have multiple access points to the external network 190. The storage controller 110 stores incoming data on the internal storage media.

Still referring to FIG. 1, a client 180 sends a request 172 in process S300 via the external network 190 to a controller 110 of the storage system 100. The controller 110 receives the request 172 in process S310 and serves the request 172 in process S320. Then the controller 110 sends a corresponding response 174 in process S330 via the external network 190 to the requesting client 180, which receives the response 174 in process 5340. If processing of the request 172 takes too long, an Input/output handler of the external device 180 generates a timeout error to the application. Applications may not be well prepared for such errors—so these errors may result in an application abort, potentially leaving inconsistent data on the storage system 100 causing data corruption.

Processing time of requests 172 increases as the amount of concurrent requests 172 increases. In other words if more and more clients 180 issue requests 172 to a storage subsystem 100 the processing time for each individual client request 172 increases gradually approaching a timeout threshold To.

Given the above it is only a matter of loading a storage system 100 with enough I/O requests 172 to cause timeouts at the connected clients 180.

Observing common access to the storage system 100 of the network attached storage (NAS) systems 1 shows, that clients 180 or applications/processes on the client 180 send a service request 172 like store, read, create, delete etc. to the storage system 100, wait for completion and then issue the next request 172.

Still referring to FIG. 2, the quicker the shown sequence (process S300 to process 5340) is completed, the more of these sequences can be performed within a given period of time. As a consequence more load, i.e. I/O requests 172, can be put on the network attached storage (NAS) system 1 by that network attached storage (NAS) client 180.

If a completion time Tc, defined as time duration between process S300 “Send Request” and process 5340 “Receive Response”, exceeds the client timeout threshold value To, the request 172 is discarded and data might get lost if the application is not prepared to handle that situation.

The completion time Tc is mostly determined by process S320, “Serve Request”. The more requests 172 are received by multiple clients 180, the more the average service time increases, and with it the probability that an individual request 172 may take longer than the timeout threshold value To.

It is important to note that with enterprise storage systems 100 it is common that many clients 180 are issuing I/O requests 172 concurrently (thousands). An example for illustration are universities where thousands of students access data over a network attached storage (NAS) protocol that is stored on a single shared storage subsystem 100.

Referring to FIG. 3, increasing the load will push the distribution as indicated in the diagram up and right, exponentially with increased load. So a tail of the shifted diagram will quickly cover the range where the completion time Tc exceeds the client timeout threshold value To, causing client disconnects, and even under high load, a substantial fraction of requests 172 will be served much before reaching the timeout threshold value To.

### SUMMARY

The technical problem underlying the present invention is to provide a network attached storage system and a corresponding method for request handling in a network attached storage system, which are able to maintain client connection and to prevent timeout in a network attached storage and to solve the above mentioned shortcomings and pain points of prior art request handling in a network attached storage system.

According to the present invention this problem is solved by providing a network attached storage system having the features of claim 1, a method for request handling in a network attached storage system having the features of claim 9, a data processing program for request handling in a network attached storage system having the features of claim 14, and a computer program product for request handling in a network attached storage system having the features of claim 15. Advantageous embodiments of the present invention are mentioned in the subclaims.

Accordingly, in an embodiment of the present invention a network attached storage system comprises a storage system connected to at least one external device via an external network, wherein the storage system comprises at least one storage media and at least one controller presenting storage capacity of the storage system to the at least one external device. The at least one external device sends a request to the storage system, wherein the at least one controller receives and serves the request and sends a response to the requesting external device after serving the request. Further the at least one controller comprises a delay functionality, which introduces a variable length delay to an execution process of the request based on a current input/output load of the storage system, a maximum allowed request response time, a request completion time, and a measured current request execution time.

In further embodiments of the present invention, the at least one controller turns off the delay functionality completely, when an input/output load of the storage system falls below a certain load threshold value and no external device experiences a timeout condition, in which the completion time of the request exceeds the maximum allowed request response time value.

In further embodiments of the present invention, the delay functionality of the at least one controller measures the current request execution time after serving the request and determines the request completion time of the corresponding request based on the measured request execution time.

In further embodiments of the present invention, the delay functionality adds no delay to the execution process of the request, when the request completion time exceeds a certain threshold value, which is smaller than the maximum allowed request response time value.

In further embodiments of the present invention, the delay functionality adds an individual delay time duration to the execution process of the request, when the request completion time falls below a certain threshold value.

In further embodiments of the present invention, the delay functionality determines the individual delay time duration, so that the a sum of the measured request execution time and the individual delay time duration approaches the maximum allowed request response time.

In further embodiments of the present invention, the delay functionality determines the individual delay time duration by calculating a difference between the measured current execution time or the determined request completion time of the request and the maximum allowed request response time of the request.

In further embodiments of the present invention, the delay functionality determines an individual maximum allowed request response time for each external device.

In another embodiment of the present invention, a method for request handling in a network attached storage system comprising a storage system connected to at least one external device via an external network, wherein the storage system comprises at least one storage media and at least one controller presenting storage capacity of the storage system to the at least one external device, said method comprises: Sending a request to the storage system by the at least one external device, receiving and serving the request by the at least one controller of the storage system; introducing a variable length delay to an execution process of the request by a delay functionality of the at least one controller based on a current input/output load of the storage system, a maximum allowed request response time, a request completion time, and a measured execution time; sending a response to the requesting external device by the at least one controller; and receiving the response by the at least one external device.

In further embodiments of the present invention, the delay functionality is turned off completely, when an input/output load of the storage system falls below a certain load threshold value and no external device experiences a timeout condition, in which the completion time of the request exceeds the maximum allowed request response time value.

In further embodiments of the present invention, the current request execution time is measured after serving the request, and the request completion time of the corresponding request is determined based on the measured request execution time.

In further embodiments of the present invention, no delay time duration is add to the execution process of the request, when the request completion time exceeds a certain threshold value; and wherein an individual delay time duration is add to the execution process of the request, when the request completion time falls below a certain threshold value.

In further embodiments of the present invention, the individual delay time duration is determined in a way that a sum of the request execution time and the individual delay time duration approaches the maximum allowed request response time.

In another embodiment of the present invention, a data processing program for execution in a data processing system comprises software code portions for performing a method for request handling in a network attached storage system when the program is run on the data processing system.

In yet another embodiment of the present invention, a computer program product stored on a computer-usable medium, comprises computer-readable program means for causing a computer to perform a method for request handling in a network attached storage system when the program is run on the computer.

All in all, embodiments of the present invention introduce an intelligent delay functionality which introduces an I/O request delay of variable length. The delay functionality can be turned off completely when the system has low load and no clients experience timeouts. When turned on, the delay functionality will add no delay time to I/O requests that take long, thus it does not make the situation worse. Further, when turned on, the delay functionality adds a delay for all I/O requests that are well below the acceptable timeout threshold To of the clients. This delay is determined for each individual request. It is adjusted so that the completion time Tc approaches but stays below the client timeout threshold To. Since this delay is determined after serving the request, the delay duration can be exactly calculated, causing all requests to be served in a very similar time.

As a consequence keeping the sequential nature of individual clients in mind, the total amount of fast responding requests is reduced, in the case where the intelligent delay functionality is turned on. At first this might seem contra-productive but in the context of network attached storage (NAS) systems with many concurrent connected clients this adds a significant benefit. By doing this, embodiments of the present invention remove some load from the system, allowing it to reduce the average service time and thereby reduce the probability of individual requests exceeding the acceptable timeout threshold To of clients. It needs to be stressed again that an I/O request timing out is disruptive to clients while an I/O request that takes longer but does not timeout will fully be tolerated by the client.

In summary, to improve the short comings and problems of prior art solutions outlined in the background section embodiments of the present invention introduce an intelligent delay functionality which optionally adds a delay process for each service request with variable delay duration. This delay process is placed after the serving the actual request.

The above, as well as additional purposes, features, and advantages of the present invention will become apparent in the following detailed written description.

### BRIEF DESCRIPTION OF THE SEVERAL VIEWS OF THE DRAWINGS

A preferred embodiment of the present invention, as described in detail below, is shown in the drawings, in which:

FIG. 1 is a schematic flow diagram of a prior art method for request handling in a network attached storage system;

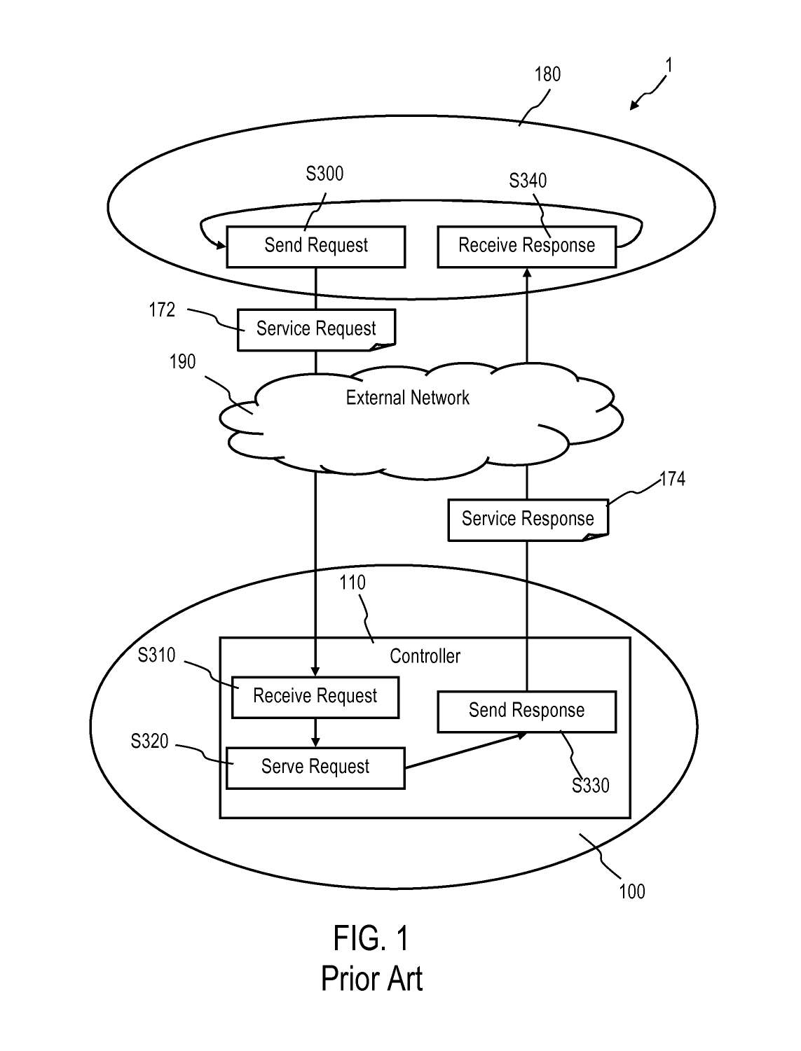

FIG. 2 is a schematic diagram of the distribution of completion time for a fixed load, in accordance with the prior art method for request handling in a network attached storage system of FIG. 1;

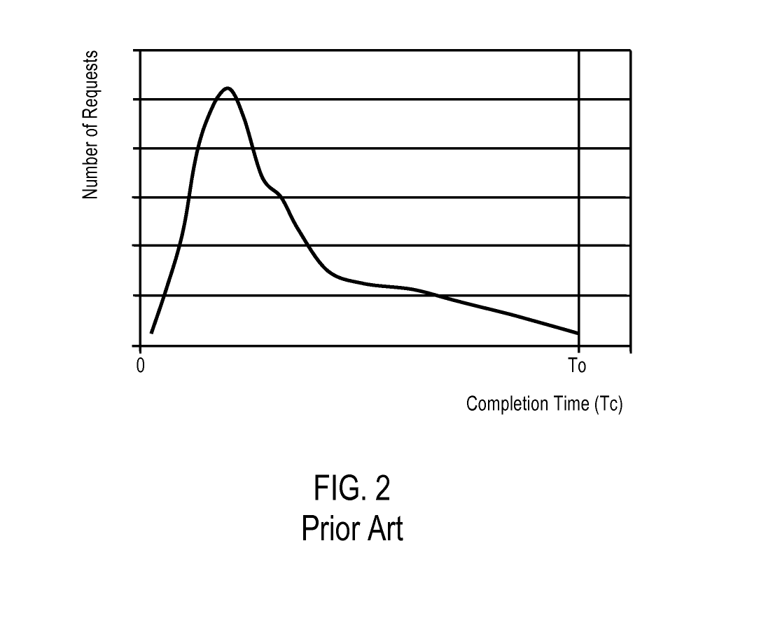

FIG. 3 is a block diagram of a network attached storage (NAS) system, in accordance with an embodiment of the present invention;

FIG. 4 is a schematic flow diagram of a method for request handling in a network attached storage system, in accordance with an embodiment of the present invention;

FIG. 5 is a more detailed schematic flow diagram of the method for request handling in a network attached storage system of FIG. 4, in accordance with an embodiment of the present invention; and

FIG. 6 is a schematic diagram of the distribution of completion time for a fixed load, in accordance with the method for request handling in a network attached storage system of FIGS. 4 and 5.

### DETAILED DESCRIPTION

The present invention may be a system, a method, and/or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational processes to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

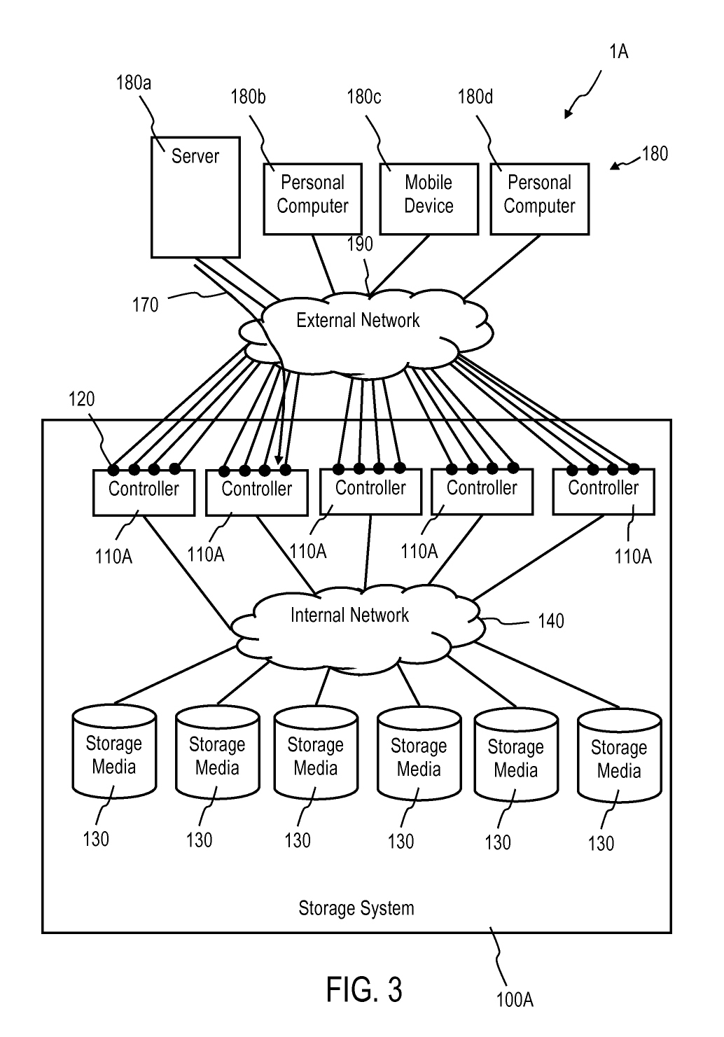

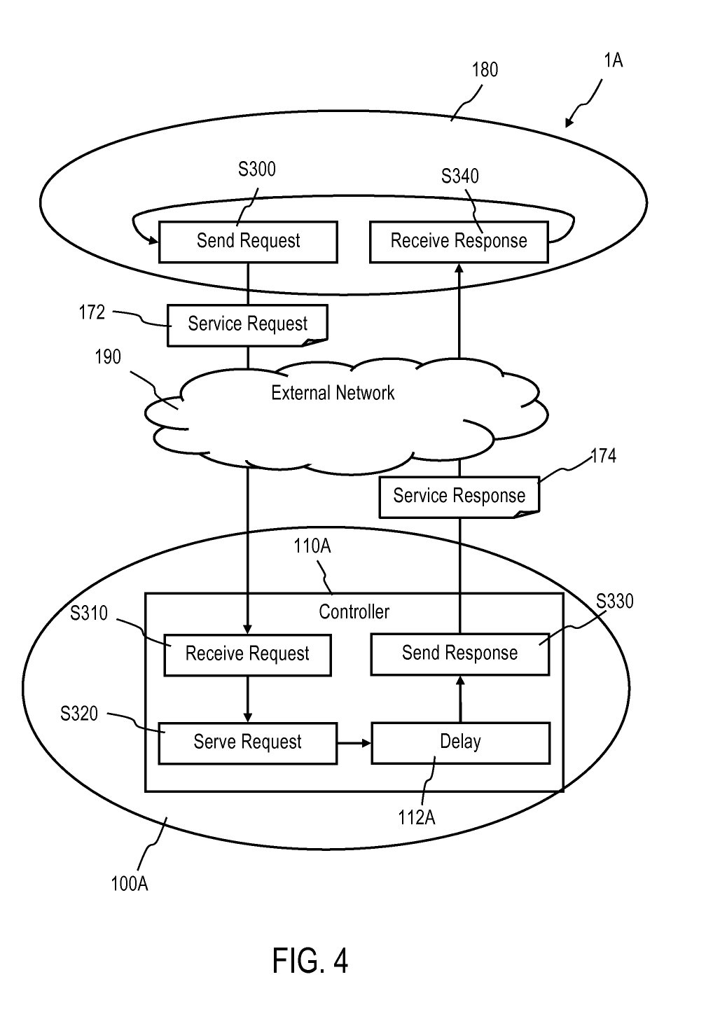

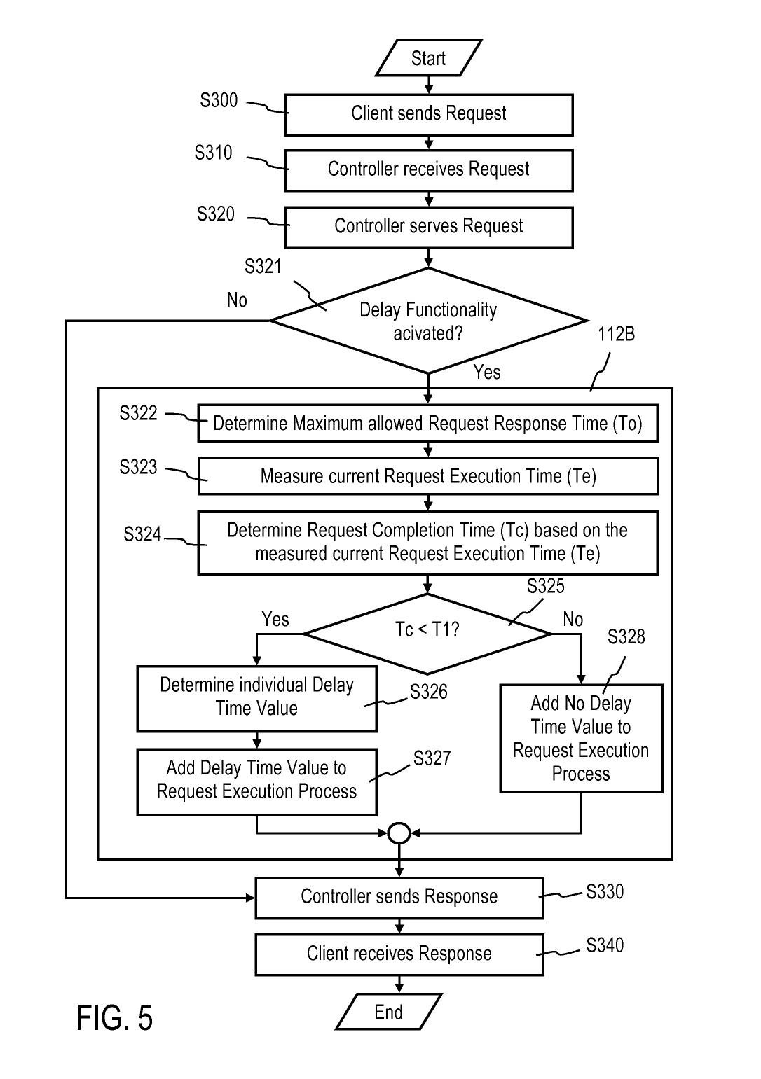

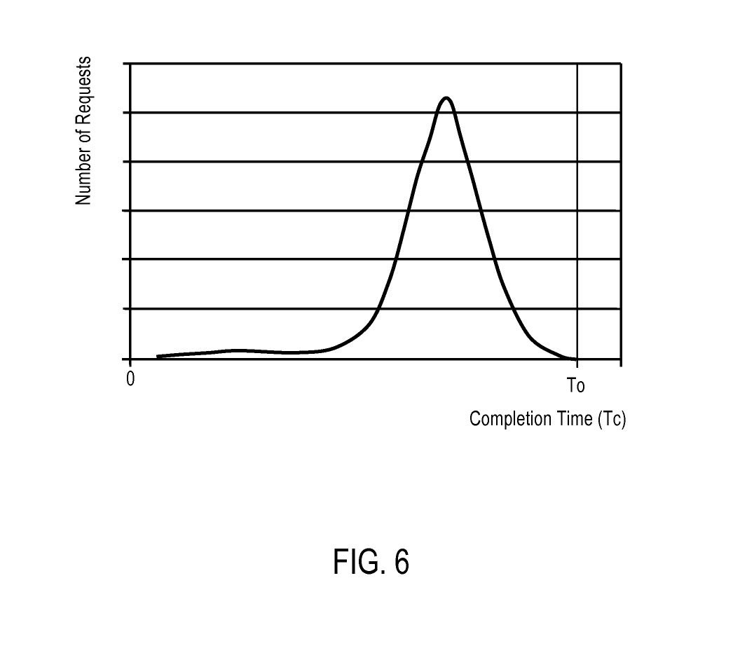

FIG. 3 shows a network attached storage (NAS) system, in accordance with an embodiment of the present invention; FIGS. 4 and 5 each show a method for request handling in a network attached storage system, in accordance with an embodiment of the present invention; and FIG. 6 shows the distribution of completion time for a fixed load, in accordance with the method for request handling in a network attached storage system of FIGS. 4 and 5.

Referring to FIGS. 3 and 4, the shown embodiment of the present invention employs a network attached storage system 1A comprising a storage system 100A. The storage system 100A comprises two or more controllers 110A which present the storage capacity of the storage system 100A via an external network 190 to one or more clients 180, e.g. server 180a, personal computer 180b, mobile device 180c and smart device 180d. Each storage controller 110A can have multiple access points 120 to the external network 190. The storage controller 110A stores incoming data on the internal storage media 130, e.g. disk drive, tape cartridge, Solid State Disk (SSD), none volatile RAM, via the internal network 140, e.g. Fibre Channel, TCP/IP, Ethernet, and InfiniBand. The storage system 100A can comprise multiple internal storage media 130 and multiple internal networks 140. Storage systems 100A with more than two controllers 110A are also called clustered storage system.

A connection 170 from an external device 180 via network 190 and an access point 120 to a controller 110A is used to read and write data to the storage system 100A. File-based data protocols like NFS, CIFS, FTP and HTTP are used to handle the data transfer between the external device 180 and the storage system 100A. The at least one external device 180 sends a request 172 to the storage system 100A, wherein the at least one controller 110A receives and serves the request 172 and sends a response 174 to the requesting external device 180 after serving the request 172. The at least one controller 110A comprises a delay functionality 112A, which introduces a variable length delay to an execution process of the request 172 based on a current input/output load of the storage system 100A, a maximum allowed request response time To, a request completion time Tc, and a measured current request execution time Te.

Referring to FIGS. 4 and 5, the shown embodiment of the present invention employs a method for request handling in a network attached storage system 1A comprising the processes of: Sending a request 172 to the storage system 100A via the external network 190 by the at least one external device 180 in process S300. In process S310 the at least one controller 110A of the storage system 100A receives the request 172 and serves the request 172 in process S320. Between process S320 and process S330 the delay functionality 112A introduces a variable length delay to an execution process of the request 172 based on a current input/output load of the storage system 100A, a maximum allowed request response time To, a request completion time Tc, and a measured execution time Te. In process S330 the at least one controller 110A sends a response 174 to the requesting external device 180 via the external network 190. In process 5340 the at least one external device 180 receives the response 174.

Referring to FIG. 5, to introduces a variable length delay to the execution process of the request 172 the at least one controller 110A proofs in process 5321, if the delay functionality 112A is activated. If the delay functionality 112A is not activated the process continues with process S330 and sends a corresponding response 174 to the requesting client 180 via the external network 190. The delay functionality 112A is turned off completely, for example, when an input/output load of the storage system 100A falls below a certain load threshold value and no external device 180 experiences a timeout condition, in which the completion time Tc of the request 172 exceeds the maximum allowed request response time value To. If the delay functionality 112A is activated, a maximum allowed request response time value To is determined in process 5322 and the current request execution time Te is measured in process 5323. In process S324 the request completion time Tc of the corresponding request 172 is determined based on the measured request execution time Te in process S324. In process 5325 the delay functionality 112A compares the determined request completion time Tc with a certain threshold value T1 which is smaller than the maximum allowed request response time value To. If the request completion time Tc falls below the certain threshold value T1, the delay functionality 112A determines an individual delay time duration in process 5326 and adds the determined delay time duration to the execution process of the request 172 in process 5327. Wherein no delay is add to the execution process of the request 172 in process 5328, when the request completion time Tc corresponds to or exceeds the certain threshold value T1.

The delay duration is determined by the difference of measured execution time Te of the request 172 and the overall suggested response time Tc by the delay functionality 112A of the I/O request controller 110A, for example. The I/O request controller 110A determines a target response time based on the overall system load. If it detects the system is overloaded, it will select the protocol based maximum acceptable response time.

Referring to FIG. 6, the embodiments of the present invention introduce the delay functionality 112A which adds variable length delay to the execution process of the request 172. The delay functionality 112A can be turned off completely when the system 1A has low load and no clients 180 experience timeouts. When turned on, the delay functionality 112A will add no delay time to I/O requests that take long, but the delay functionality 112A adds a delay for all I/O requests that are well below the acceptable timeout threshold To of the clients 180. This delay is determined for each individual request 172. It is adjusted so that the completion time Tc approaches but stays below the client timeout threshold To. For example, the individual delay time duration is determined in a way, that a sum of the measured request execution time Te and the individual delay time duration approaches the maximum allowed request response time To. Since this delay is determined after serving the request 172, the delay duration can be exactly calculated, causing all requests 172 to be served in a very similar time, as shown in FIG. 6. Therefore embodiments of the present invention remove some load from the system 1A, allowing the system 1A to reduce the average service time and thereby reduce the probability of individual requests 172 exceeding the acceptable timeout threshold To of clients 180.

Thus if system load is increasing which is indicated by long average response times, the delay functionality 112A adds delay durations only to individual quick requests 172 that are still distant from the timeout threshold value To on average escalating response times.

In the shown embodiment the delay functionality 112A determines the maximum allowed response time To by individual connection, so that each client 180 could have a different timeout threshold value To based on a version of the client implementation, and individual requests will have delay durations that stay below the client timeout threshold limit To of the individual connection.

In an alternative embodiment a variable delay “response time goal” allows a smooth variation in a range from “no extra delay” to “maximum extra delay”, based on the detected load and/or an average response time.

Embodiments of the present invention furthermore permit even higher granular handling of client I/O requests than what is possible in prior art. In another embodiment the I/O request controller 110A together with the intelligent delay functionality 112A can treat particular clients 180 or pool of clients in a preferred way. Specific clients, for example connecting with a particular IP address, might be given higher priority and/or smaller and/or no I/O response time escalation than other connected clients given a higher response time escalation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A network attached storage system comprising a storage system configured to be connected to at least one external device via an external network, wherein said storage system comprises at least one storage media and at least one controller configured to present storage capacity of said storage system to said at least one external device, wherein said at least one controller receives and serves a request from said external device and sends a response to said requesting external device after serving said request;
wherein said at least one controller determines a variable length delay, which introduces a variable length delay to an execution process of said request based on a current input/output load of said storage system, a maximum allowed request response time, a request completion time, and a measured current request execution time.

2. The network attached storage system according to claim 1, wherein said at least one controller turns off said delay functionality completely, when an input/output load of said storage system falls below a certain load threshold value and no external device experiences a timeout condition, in which said completion time of said request exceeds said maximum allowed request response time value.

3. The network attached storage system according to claim 1, wherein said at least one controller measures said current request execution time after serving said request and determines said request completion time of said corresponding request based on the measured request execution time.

4. The network attached storage system according to claim 1, wherein said at least one controller adds no delay to said execution process of said request, when said request completion time exceeds a certain threshold value, which is smaller than said maximum allowed request response time value.

5. The network attached storage system according to claim 1, wherein said at least one controller adds an individual delay time duration to said execution process of said request, when said request completion time falls below a certain threshold value.

6. The network attached storage system according to claim 5, wherein said at least one controller determines said individual delay time duration, so that said a sum of the measured request execution time and said individual delay time duration approaches said maximum allowed request response time.

7. The network attached storage system according to claim 6, wherein said at least one controller determines said individual delay time duration by calculating a difference between said measured current execution time or said determined request completion time of said request and said maximum allowed request response time of said request.

8. The network attached storage system according to claim 1, wherein said at least one controller determines an individual maximum allowed request response time for each external device.

9. A method for request handling in a network attached storage system comprising a storage system connected to at least one external device via an external network, wherein said storage system comprises at least one storage media and at least one controller presenting storage capacity of said storage system to said at least one external device, said method comprising:
receiving and serving a request from an external device by said at least one controller of said storage system;
introducing a variable length delay to an execution process of said request by a delay functionality of said at least one controller based on a current input/output load of said storage system, a maximum allowed request response time, a request completion time, and a measured current request execution time; and
sending a response to said external device by said at least one controller.

10. The method according to claim 9, wherein said delay functionality is turned off completely, when an input/output load of said storage system falls below a certain load threshold value and no external device experiences a timeout condition, in which said completion time of said request exceeds said maximum allowed request response time value.

11. The method according to claim 9, wherein said current request execution time is measured after serving said request, and said request completion time of said corresponding request is determined based on the measured request execution time.

12. The method according to claim 9, wherein no delay is added to said execution process of said request, when said request completion time exceeds a certain threshold value; and
wherein an individual delay time duration is added to said execution process of said request, when said request completion time falls below a certain threshold value.

13. The method according to claim 12, wherein said individual delay time duration is determined in a way, that a sum of said request execution time and said individual delay time duration approaches said maximum allowed request response time.

14. A data processing program for execution in a data processing system comprising software code portions for performing a method for request handling in a network attached storage system according to claim 9 when said program is run on said data processing system.

15. A computer program product for request handling in a network attached storage system comprising a storage system configured to be connected to at least one external device via an external network, wherein said storage system comprises at least one storage media and at least one controller configured to present storage capacity of said storage system to said at least one external device, said computer program product comprising:
one or more computer readable storage media and program instructions stored on the one or more computer readable storage media, the program instructions comprising:
program instructions to receive and serve a request from an external device by said at least one controller of said storage system;
program instructions to introduce a variable length delay to an execution process of said request by a delay functionality of said at least one controller based on a current input/output load of said storage system, a maximum allowed request response time, a request completion time, and a measured current request execution time; and
program instructions to send a response to said external device by said at least one controller.

16. The computer program product according to claim 15, wherein said delay functionality is turned off completely, when an input/output load of said storage system falls below a certain load threshold value and no external device experiences a timeout condition, in which said completion time of said request exceeds said maximum allowed request response time value.

17. The computer program product according to claim 15, wherein said current request execution time is measured after serving said request, and said request completion time of said corresponding request is determined based on the measured request execution time.

18. The computer program product according to claim 15, wherein no delay is added to said execution process of said request, when said request completion time exceeds a certain threshold value; and
wherein an individual delay time duration is added to said execution process of said request, when said request completion time falls below a certain threshold value.

19. The computer program product according to claim 18, wherein said individual delay time duration is determined in a way, that a sum of said request execution time and said individual delay time duration approaches said maximum allowed request response time.
